(19) United States
(12) Patent Application Publication
(10) Pub. No.: US 2016/0114360 A1
(43) Pub. Date: Apr. 28, 2016

(54) STEAM CLEANER FOR BAFFLE-TYPE GREASE FILTERS

(71) Applicant: Darcy McMenamin, Holbrook, MA (US)

(72) Inventor: Darcy McMenamin, Holbrook, MA (US)

(21) Appl. No.: 14/925,923

(22) Filed: Oct. 28, 2015

Related U.S. Application Data
(60) Provisional application No. 62/069,791, filed on Oct. 28, 2014.

(51) Int. Cl. B08B 3/10

(52) U.S. Cl. CPC B08B 3/10

(57) ABSTRACT

Improved systems, methods, and apparatuses for the periodic cleaning of certain baffle-type grease filters are provided for. In one embodiment, a steam nozzle, a steam hose, and a steam production unit are provided with a steam nozzle with a plurality of steam venting holes, a scouring surface, and ridges that are spaced and sized to engage with the grooves on a baffle-type grease filter.

### BACKGROUND

Embodiments of the invention relate generally to improved systems, methods, and apparatuses for the periodic cleaning of certain baffle-type grease filters which are commonly used in industrial or commercial kitchens through the use of steam. Baffle-type grease filters are commonly known within the commercial kitchen industry as a technique for removing separating entrained grease from a flow of air, typically in an exhaust hood, extractor hood, or range hood, which are devices containing a mechanical fan that hangs above the stove or to cooktop in the kitchen. It removes airborne grease, combustion products, fumes, smoke, odors, heat, and steam from the air by evacuation of the air and filtration. Baffle filters force the air to move through a series of baffles, forcing it into a series of 180-degree turns, causing the grease to be deposited in the bends of the baffles.

Baffle-type filters are typically cleaned by removing the various components of the baffle filter, placing them within an industrial dishwasher, and then re-installing them. This process generally requires the removal of the baffle filters, the grease tray, and periodic removal of the blower fans for cleaning. Once the components have been removed, they are placed in an industrial-grade dishwasher or individually washed by hand using water and chemicals that are known in the commercial kitchen industry. After the components are cleaned and dried, they are manually re-installed into the exhaust hood.

This cleaning process is generally performed once a day or every other day, although some components, such as the grease trap, and the fans, are generally cleaned less frequently. As a result of these regular cleanings, an average restaurant can expect to pay approximately $5000 or more per year to clean its baffle-type grease filters, using these traditional methods. Traditional cleaning methods also produce approximately 10,000 gallons of waste water per year for an average commercial kitchen.

### SUMMARY

Embodiments of the invention relate to systems, methods, and apparatuses for cleaning baffle-type grease filters in place without the need to remove or re-install the components for such filters and without the need to use industrial dishwashers. In one embodiment, a hand-held steam cleaner is designed and configured to force hot steam through the baffle-type filter, thereby melting any grease deposited on the baffles and allowing it to flow into the grease trap. Kitchen workers can simply and quickly clean baffle-type grease filters without wasting the time or resources associated with removing and re-installing them on a nightly or semi-nightly basis. Certain embodiments also significantly reduce the amount of wastewater produced by commercial kitchens by removing the need to clean baffle-type grease filters through an industrial dishwasher.

In one embodiment, a hand-held steam cleaner is designed and configured to produce steam at temperatures greater than 180 degrees, which is the approximate temperature at which grease liquefies. The hand-held steam cleaner also includes a controlled pressure release so that grease is not forced into the hood, but instead flows into the grease trough and into the grease to pans. The hand-held steam cleaner also includes a spray nozzle in a form and shape that improves surface area contact with the grooves on the front of the baffle-type grease filter.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The use of such terms herein are not necessarily all referring to the same embodiment. The accompanying drawings are included to provide illustration and a further understanding of the various aspects and embodiments, and are incorporated in and constitute a part of this specification.

### BRIEF DESCRIPTION OF THE DRAWINGS

Various aspects of at least one embodiment are discussed below with reference to the accompanying figures. Where technical features in the figures or detailed description are followed by reference signs, the reference signs have been included for the sole purpose of increasing the intelligibility of the figures or detailed description. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1A is a frontal view of a typical baffle-type grease filter;

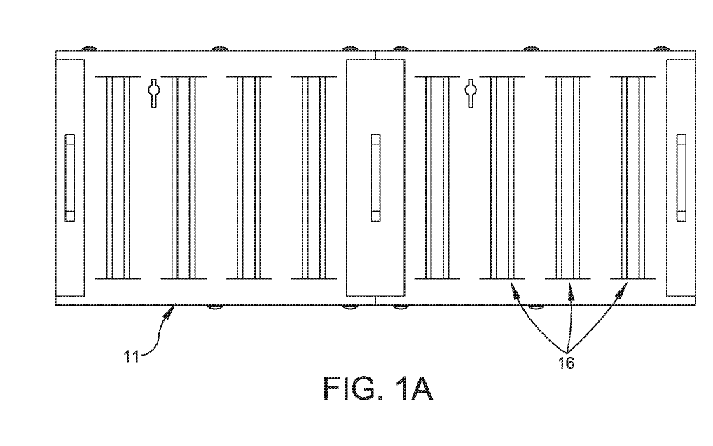

FIG. 1B is a top view of a typical baffle-type filter;

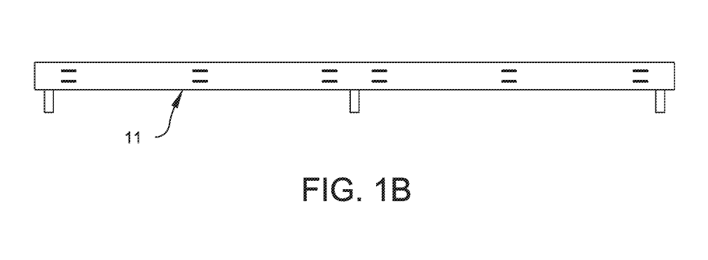

FIG. 1C is a left side view of a typical baffle-type filter;

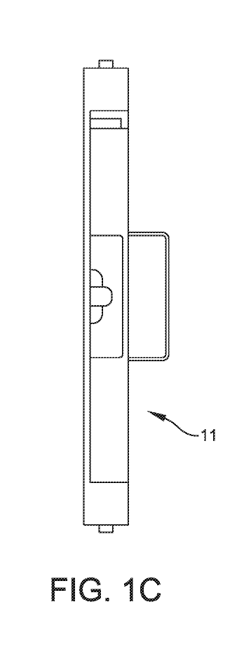

FIG. 1D is a right side view of a typical baffle-type filter;

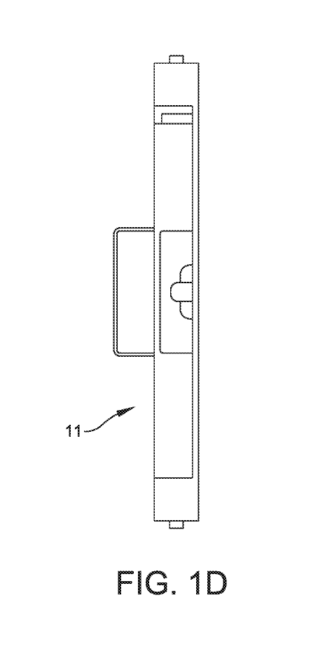

FIG. 1E is a perspective view of a typical baffle-type filter;

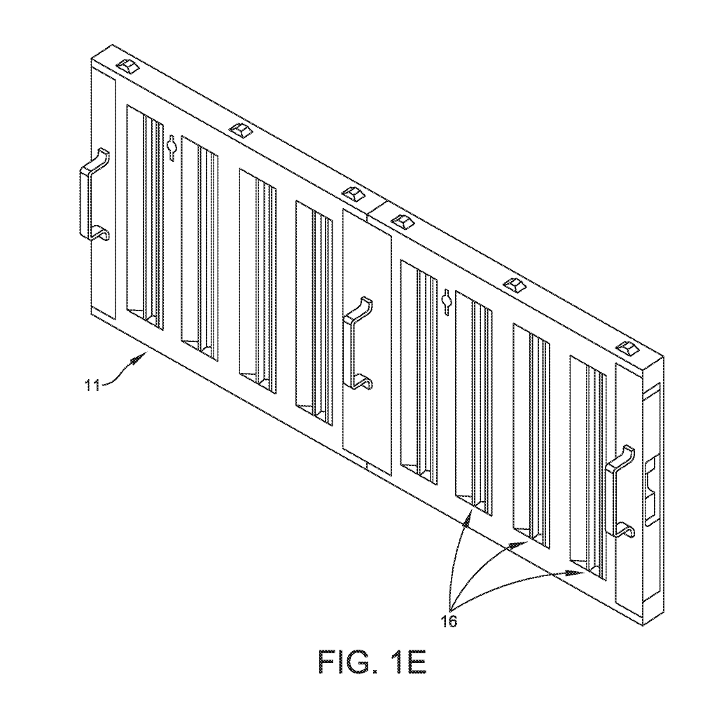

FIG. 2 is an embodiment of a hand-held steam cleaner.

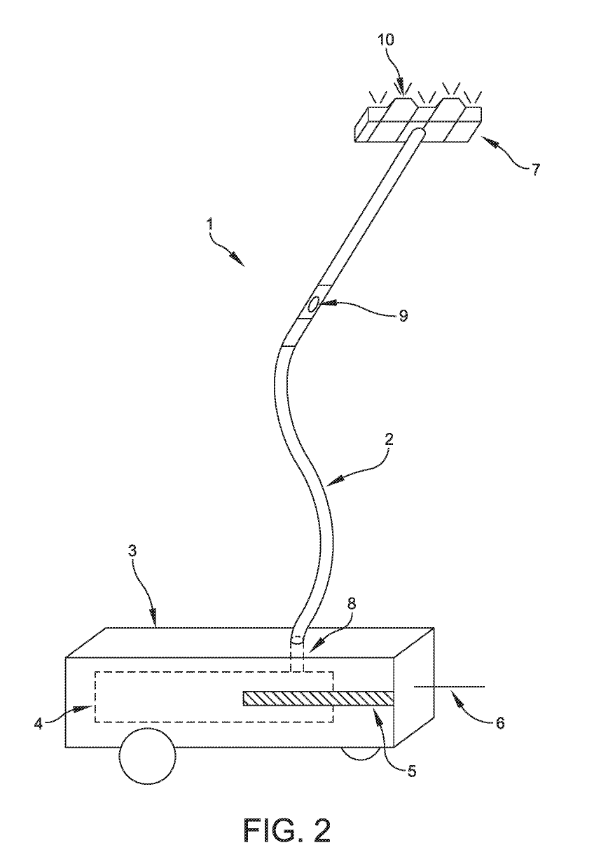

FIG. 3 is an embodiment of a cleaning surface of a nozzle for a hand-held steam cleaner.

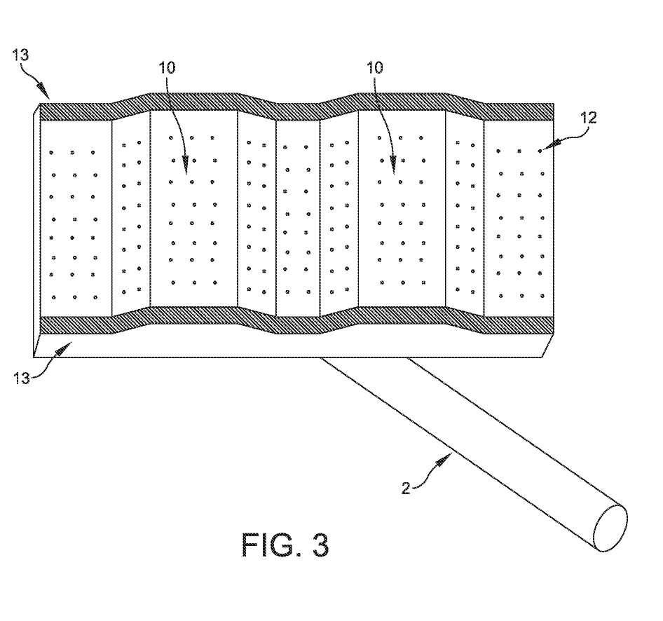

### DETAILED DESCRIPTION

One embodiment employs a hand-held steam cleaner that is designed and configured to force hot steam through the baffle-type filter, thereby melting any grease deposited on the baffles and allowing it to flow into the grease trap.

The handheld steam cleaner 1 is comprised of a steam nozzle 7 that may be connected to steam unit 3 via steam hose 2. Steam unit 3 may be comprised of a water tank 4, heating element 5, and steam release valve 8. Water tank 4 may hold between ½ and 1 gallon of water. Steam unit 3 preferably accepts a standard voltage of 120 volts via electrical cord 6. In another embodiment, steam unit 3 may be powered by a rechargeable battery pack. Steam unit 3, hose 2, and steam nozzle 7, are preferably made, in part, of stainless steel material. In yet further embodiments, handheld steam cleaner 1 and steam unit 3 may be housed in a single, handheld configuration.

In some embodiments, water is added to tank 4 and heated until it boils and becomes vapor. Steam is applied to the baffle-type grease filter by applying steam nozzle 7 to the underside of baffle-type grease filter 11 and activating the steam release valve 8 by pressing control switch 9. Steam nozzle 7 is preferably designed with ridges 10 that fit into the grooved surface of baffle-type grease filter 11. Standard baffle-type grease filters are 20″×16″, 20″×20″, 20″×25″, although these sizes are typical and are not required. Ridges 10 are preferably arranged and sized so as to fit into the grooves 16 on the baffle-type grease filter 11. The grooves on a typical baffle-type grease filter vary between 3″ and 5″ slots, although other spacing may alternatively be used. In some embodiments, nozzle 7 may be adjustable to allow for use with baffle-type grease filters with different spacing between grooves 16.

Upon actuating the steam release valve 8 by pressing control switch 9, hot steam is released from water tank 4 via steam release valve 8, travels through steam hose 2, and is released through steam nozzle 7. Steam nozzle 7 is perforated with small steam holes 12, preferably between 1 mm and 5 mm in diameter. In some embodiments, steam nozzle 7 is equipped with a scouring material 13 in addition to steam holes 12 in order to aid in the cleaning process.

Steam should be heated to approximately 180° F. to facilitate the removal of grease that is trapped within the baffle-type filters 11. Preferably, steam is heated to at least 200° F., but no more than 220° F. Steam should also preferably be sufficiently pressurized to effectively to deliver hot steam throughout baffle-type filter 11 without forcing the solidified grease to be pushed further into the baffle-type grease filter 11 or the exhaust fans. The steam should preferably be delivered at no more than 1500 PSI.

Once the hot steam exits steam holes 12, it passes through baffle-type grease filter 11, contacting the solidified grease, and heating it to its approximate melting point of 180° F. Whereupon, liquefied grease travels into a grease trough and from there into a grease pan. The grease pan must be periodically cleaned in order to prevent excessive accumulation of grease. The user preferably applies steam nozzle 7 across the entire surface of baffle-type grease filter 11 in a sweeping motion until the surface of baffle type grease filter 11 appears clean and free of grease.

Embodiments of the steam cleaner may be used to reduce the water necessary to clean a baffle-type grease filter and also reduces the amount of wastewater released by a kitchen by reducing the need to wash baffle-type grease filters in a dishwasher. Embodiments of the steam cleaner also significantly reduce the amount of grease that is discharged by the commercial kitchen into its plumbing and sewer system, which is a significant source of plumbing complications in a commercial kitchen. It is estimated that embodiments of the steam cleaner may reduce water consumption by approximately 9,500 gallons a year in a typical commercial kitchen. The steam cleaner also allows commercial kitchens to capture and store a greater percentage of grease, which may be recycled.

One should appreciate that embodiments of the invention are not limited to the details of construction and the arrangement of components set forth in the foregoing description or illustrated in the drawings. The inventions are capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. An apparatus for cleaning baffle-type grease filters comprising:
a steam nozzle, a steam hose, and a steam production unit wherein said steam production unit includes a water tank and a heating element;
a control switch for actuating a steam release valve;
a steam nozzle with a plurality of steam venting holes, a scouring surface, and ridges that are spaced and sized to engage with the grooves on a baffle-type grease filter.
